(19) United States
(12) Patent Application Publication
(10) Pub. No.: US 2013/0169090 A1
(43) Pub. Date: Jul. 4, 2013

(54) MOTOR

(71) Applicant: Tokuro KUSUNOKI, Koshu-shi (JP)

(72) Inventor: Tokuro KUSUNOKI, Koshu-shi (JP)

(21) Appl. No.: 13/727,289

(22) Filed: Dec. 26, 2012

(30) Foreign Application Priority Data
Dec. 28, 2011 (JP) 2011-287703

(51) Int. Cl. H02K 5/10; H02K 5/16

(52) U.S. Cl. CPC H02K 5/10; H02K 5/163
USPC 310/88

(57) ABSTRACT

A brush motor includes a case, a rotor containing a wiring portion wound around an iron core fixed to a shaft, a bearing making a sliding contact with the shaft to support the shaft, and a holder holding the bearing. The holder is made of resin, and includes a central portion with a cylindrical shape, containing an inner circumferential side into which the bearing is inserted, and a top portion protruding from an opening formed in the case; and an outer circumferential portion shielding the inner surface side of the exterior case and the winding portion. Thereby, the reliability of the motor can be improved.

### BACKGROUND OF THE INVENTION

1. Field of the Invention

The present invention relates to a motor, and more particularly relates to a motor including a bearing in a sliding contact with and for supporting a rotating shaft of the motor, and a bearing holder for holding the bearing.

2. Description of the Related Art

Conventionally, in a movable body such as electric or electronic devices, automobiles and the like, motors have been widely used as actuators of rotating motion type. The motor includes a rotor and a stator. In general, the rotor gets a rotating torque by magnetic fluxes of magnets fixed in an exterior case. The rotor rotating shaft of the motor is supported by a bearing which is press-fitted into and fixed to the exterior case (for example, Japanese Laid Open Patent Publication No. 2006-094647). Further, since the motor functions as an actuator, the exterior case is provided with screw holes and the like for attaching a main body of the motor to a motor attaching member of an electric or electronic device.

In such an actuator, in order to secure a concentricity between the bearing and the motor rotating shaft, there has been disclosed a motor including a bearing and a bearing holder which are constructed in one body (for example, Japanese Patent Laid Open Patent Publication No. 2007-209178). Further, in order to prevent generation of sound or to suppress friction due to sliding movement, there has been disclosed a motor including a bearing in which oil sump portions are formed (for example, Japanese Patent Laid Open Patent Publication No. 2008-240909).

Still further, in motors, regardless of the types, a request for reduction in size and weight has been increased more and more, and the request has been a main tendency in a development of a motor along with noise reduction and power up.

On the other hand, if foreign material such as dusts (specifically, dusts of magnetic material) invades a motor through screw holes formed in an exterior case before attaching the motor, the invasion may cause a malfunction of operation of the motor. Further, when a D.C. motor is constructed by using an oil retaining bearing, there may be cases such that oil flows out to the outside of the exterior case so as to badly influence on the main body or lack of oil reduces the lifetime of the motor. Still further, the concentricity between the bearing, which defines the axis line of the rotor (rotating shaft of the motor), and the magnets arranged at the outside of the rotor is important. If the concentricity between them is lowered, it causes production of vibration or sound.

In view of the above-circumstances, an object of the present invention is to provide a motor having an improved reliability.

According to the present invention, there is provided a motor including an exterior case, a rotor containing a wiring portion wound around an iron core fixed to a rotating shaft, a bearing in a sliding contact with the rotating shaft to support the rotating shaft, and a bearing holder made of resin and arranged at one side of the rotating shaft and holding the bearing. The bearing holder includes a central portion with a cylindrical shape, containing a top portion protruding from an opening formed in the exterior case, and an inner circumferential side into which the bearing is inserted; and an outer circumferential portion shielding the inner surface side of the exterior case and the winding portion. By such a configuration, even when a screw hole for attaching the motor is formed in the exterior case, the outer circumferential portion can cut an invasion of foreign matter into the wiring portion side so that it is possible to obviate a malfunction of operation due to an invasion of foreign matter so as to improve the reliability, as well as the volume of the motor can be made small so as to realize downsizing.

### BRIEF DESCRIPTION OF THE DRAWINGS

FIG. 1 is a sectional view of a brush motor in a longitudinal direction according to an embodiment applicable to the present invention, showing a state in which it is attached to a motor attaching member.

FIG. 2 is a front view of a brush supporting configuration of the brush motor according to the embodiment when viewed from a line II-II in FIG. 1.

FIG. 3 is an exploded perspective view of the brush motor according to the embodiment.

FIG. 4 is a perspective view of a holder when viewed from an arrow IV in FIG. 3.

FIG. 5 is a plan view of the holder when viewed from the arrow IV in FIG. 3, wherein (A) is a plan view of the whole of the inside of the holder; and (B) is an expanded plan view of the vicinity of an oil sump portion.

FIG. 6 is an explanatory diagram of the flowing direction of oil, wherein (A) shows a state when the motor is running; and (B) shows a state when the motor is resting.

### DESCRIPTION OF THE PREFERRED EMBODIMENTS

In the following, with reference to the drawings, an explanation will be given about an embodiment applied to a brush motor using an oil retaining bearing.

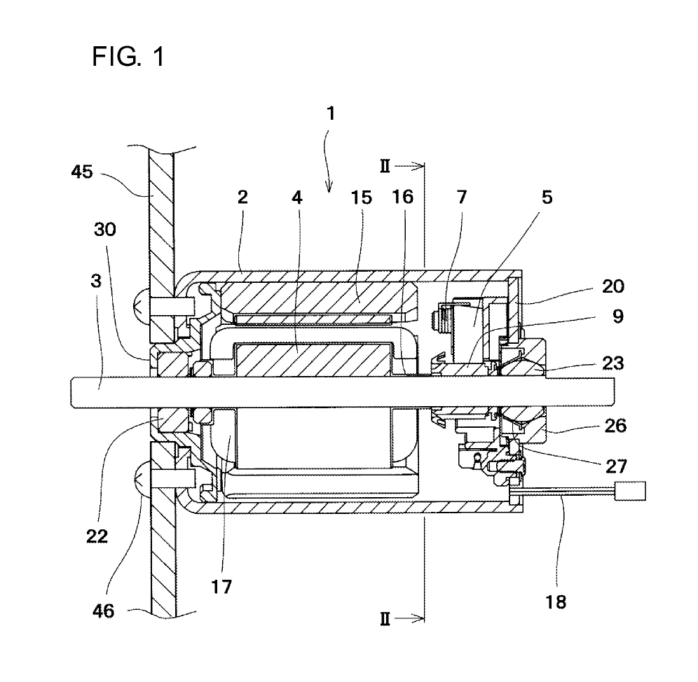

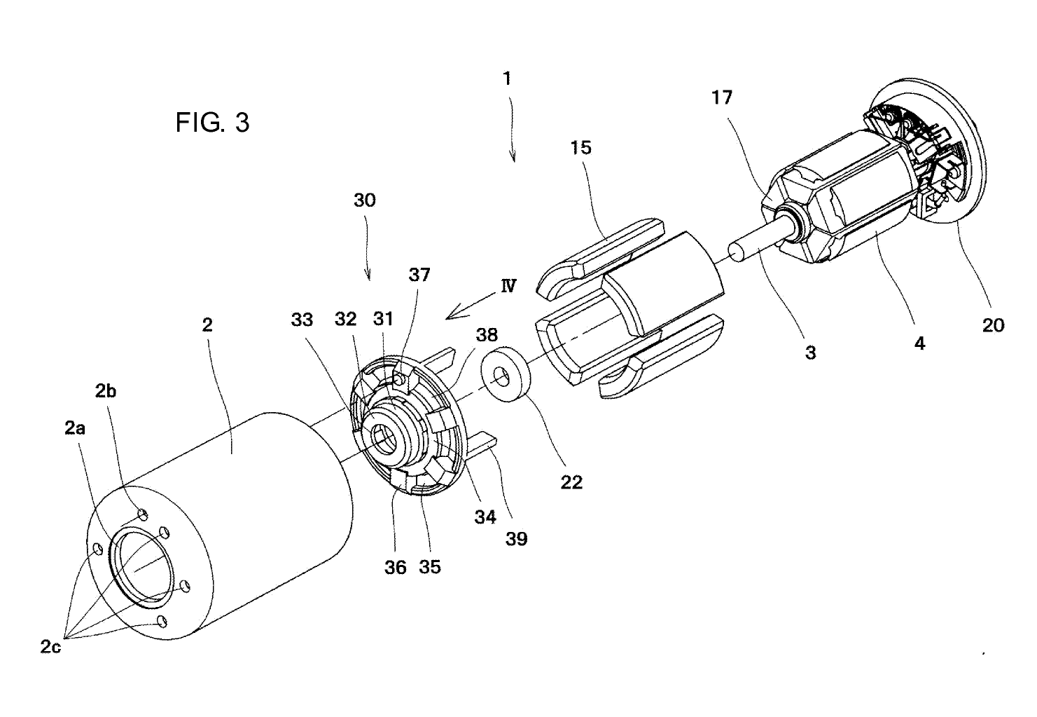

As shown in FIG. 1 and FIG. 3, a brush motor 1 according to the present embodiment includes a shaft 3 as a rotating shaft of the motor. In the present embodiment, one side (right side in FIG. 1) of the shaft 3 is shown to be cut away, however, it may also be possible to make the other side (left side in FIG. 1) to be cut away.

At a position to the left including a central portion in the longitudinal direction of the shaft 3, an iron core (core) 4, which becomes to be magnetic flux paths, is fixed to the shaft 3. Around the iron core 4, a plurality of slots (core slots) is formed. In these slots, a winding (a coil) 17 is wound a number of times. Due to this, both sides of the iron core 4 have a structure to be filled with the winding 17. Note that, between the iron core 4 and the coil 17, an insulating layer 16 (placo) is interposed to keep insulation therebetween. As the material of the insulating layer 16, epoxy resin is used for example.

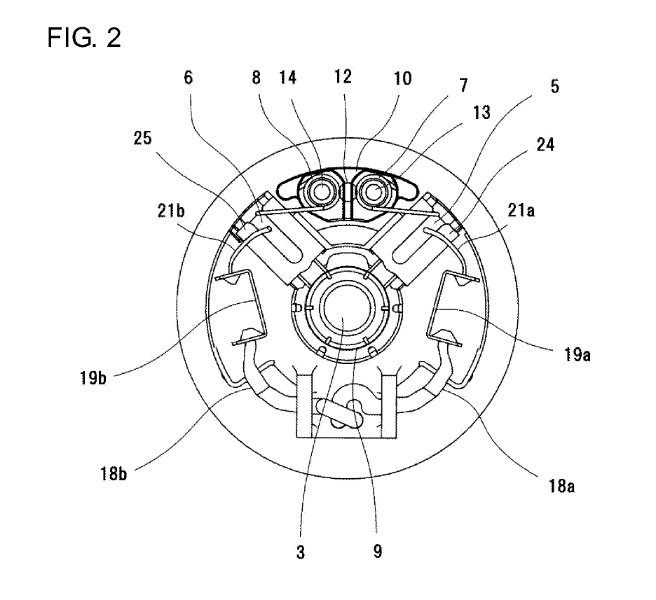

Further, to the shaft 3, at a position slightly separated from the winding 17 arranged at the one side (the right side in FIG. 1) of the iron core 4, a commutator 9 for switching the direction and the phase of the current passing through the winding 17 is fixed. In the present embodiment, the commutator 9 includes six divided pieces (see FIG. 2). Note that, at a side of the commutator 9 close to the iron core 4, a connecting portion for connecting with the winding 17 is provided.

Accordingly, in the brush motor 1, a rotor is constructed by the shaft 3, the iron core 4, the winding 17, the insulating layer 16, and the commutator 9. On the other hand, a stator side is constructed as follows.

At an outer side of the iron core 4 and the winding 17 (winding portion), there are provided four magnets (permanent magnets) 15 each having an arc-like cross section and generating magnetic fluxes necessary to generate torque of the motor (rotor). The magnets 15 are fixed at an inner circumferential side of a case 2 with equally spaced intervals.

The case 2 is formed by performing deep-drawing processing on a steel plate to form a cylindrical shape having a bottom. At a central portion of the bottom side (the left side in FIG. 1), a holder inserting hole 2a, through which a later described bearing holder portion 31 (central portion of the cylindrical shape) of a holder 30 penetrates, is formed (see FIG. 3). The reason why the steel plate is used for the case 2 is to form paths of the generated magnetic fluxes and to prevent the magnetic fluxes from leaking to the outside of the motor. Further, on the circumference portion of the holder inserting hole 2a at the bottom side of the case 2, there are formed a positioning hole 2b for positioning the holder 30 with respect to the case 2, and four screw holes 2c for attaching the brush motor 1 to a main body of an equipment.

On the other hand, the opening side of the case 2 is sealed by a disk-like bracket 20. At the center of the bracket 20, an opening for inserting a cylindrically-shaped bearing holder 26 is formed. As the material of the bracket 20, steel plate is used just like the case 2. Note that, in the present embodiment, the case 2 and the bracket 20 construct an exterior case of the brush motor 1.

The bearing holder 26 is holding a bearing 23. The bearing 23 has an inner circumferential side with a circular form so as to make a sliding contact with the shaft 3, and has an outer circumferential side with a spherical shape (the cross section has a circular form). Therefore, the bearing 23 is supported in such a way that a nearly one half of the outer circumferential of the bearing 23 abuts the bearing holder 26, and is supported in such a way that a nearly another one half of the outer circumferential of the bearing 23 abuts a metallic washer 27 accommodated in the bearing holder 26. As such, since the outer circumferential of the bearing 23 has a spherical shape, the load, which is generated when the motor is started and is applied to the output side of the shaft 3, is absorbed by the metallic washer 27 which functions as a spring also. Note that, in the bearing holder 26, a circular hole for penetrating the shaft 3 is formed.

As shown in FIG. 1 and FIG. 2, one end portion of each of a first brush 5 and a second brush 6 is pushed to be in contact with a circumferential surface of the commutator 9. The main material of the first brush 5 and the second brush 6 is black lead. These pair brushes have structures to make a sliding contact with the circumferential surface of the commutator 9. The brushes 5 and 6 are accommodated in brush cases 24 and 25 respectively in such a way that one end of each of the brushes 5 and 6 orthogonally abuts the circumferential surface of the commutator 9. Note that, in the present embodiment, the brush cases 24 and 25 are arranged in such a way that the axial directions of the brushes 5 and 6 form an angle of 90° (are orthogonal). Further, in manufacturing the brushes 5 and 6, the same things are used (material, lengths, and the like are the same).

Between the brushes 5 and 6, a supporting plate 10 made of resin is arranged. A first torsion spring 7 and a second torsion spring 8 are attached to the supporting plate 10. The supporting plate 10 has a generally fan-like shape and is constructed by a plate member. Positioning projections 13 and 14 having cylindrical shapes are provided in a protruding condition by protruding from the supporting plate 10 to the side of the magnet 15 and by inserting into coil portions of the torsion springs 7 and 8. Further, in the supporting plate 10, latching portions (spaces) for latching the respective ends of the torsion springs 7 and 8 are formed.

As shown in FIG. 2, the other ends of the torsion springs 7 and 8 respectively abut the other ends of the brushes 5 and 6 in such a way that the other ends of the torsion springs 7 and 8 respectively push and press the other ends of the brushes 5 and 6. Note that the above-mentioned brush cases 24 and 25 are configured to have notches in their longitudinal directions so that the contact by pressure against the other ends of the brushes 5 and 6 by the other ends of the torsion springs 7 and 8 is continuously kept even when the brushes 5 and 6 are worn out.

A circular hole is formed in the central portion of the supporting plate 10. A tip section of a screw 12 is inserted into the circular hole. The screw 12 has a head with a seat which abuts an outer side of the bracket 20. The screw 12 is a supporting member having a thread part screwing together with a female screw which is threadably mounted on the bracket 20. Thus, the supporting plate 10 is supported.

As shown in FIG. 1 and FIG. 2, the brush motor 1 includes lead wires 18 to be connected to the power supply. The lead wires are configured by a lead wire 18a to be connected to the negative side of the power supply, and a lead wire 18b to be connected to the positive side of the power supply. At the ends of the lead wires 18, connectors for connecting the motor to the power supply are provided. Note that the lead wires 18 are accommodated in the exterior case through a hole formed in the bracket 20.

That is, the lead 18a is connected to one side of a connecting piece 19a made of metal and having a cross section with a U-shaped, while the other end of the connecting piece 19a is connected through a connecting lead wire 21a to the brush 5. Similarly, the lead 18b is connected to one side of a connecting piece 19b made of metal and having a cross section with a U-shaped, while the other end of the connecting piece 19b is connected through a connecting lead wire 21b to the brush 6.

Next, an explanation about the holder 30 which is one of the features of the present invention will be described in detail.

As shown in FIG. 1 and in FIGS. 3-5, the holder 30 is, in one sentence, a member made of resin having a shape of a disc (the cross section of which has a shape of a hat); the center portion of which is cylindrically protruding; and the outer circumferential portion of which is provided with a plurality of projections (magnet positioning columns 39) protruding toward the magnets 15 for positioning the magnets 15. The details are as follows.

As shown in FIG. 3, on the surface side (outer side) opposite to the bottom side of the case 2 (left side in FIG. 3), a cylindrical bearing holder portion 31 for holding a (oil retaining) bearing 22 and protruding toward side of the case 2 is formed at the central portion (at the hat portion in the cross section). The top portion of the bearing holder portion 31 is flat and constitutes a planar portion 32 which protrudes toward the case. The planar portion 32 penetrates through the holder inserting hole 2a in the above-mentioned case 2. At the center of the case protruding plain portion 32, there is formed a shaft inserting hole 33 (circular hole) for inserting the shaft 3.

On the circumference of the bearing holder portion 31, a planar portion 34 having an annular shape is formed. The planar portion 34 and an annular base portion 35 positioned at a lower position (with a difference in level) than the planar portion 34 and having a diameter larger than that of the planar portion 34 are connected by a taper portion 38. From the base portion 35, blockish case abutting projections 36 for abutting an inner surface of the bottom side of the case 2 are provided in a protruding condition. In this example, the number of the case abutting projections 36 is six. The arranging intervals between adjacent case abutting projections 36 on the base portion 35 are the same. The tops of these case abutting projections 36 are made to be flush and are provided at a position higher than the planar portion 34 (close to the case 2). One case abutting projection of the six case abutting projections 36 is further provided with a pin-shaped positioning projection 37. The positioning projection 37 is inserted into the positioning hole 2b formed in the case 2. As such, since the pin-shaped positioning projection 37 is provided on one of the case abutting projections 36, the pin-shaped positioning projection 37 can be made short. Thus, the pin-shaped positioning projection 37 is not broken.

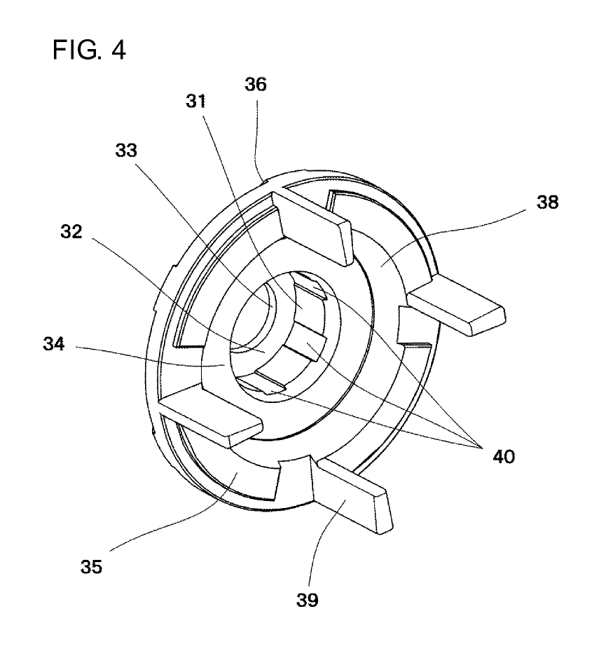

On the other hand, on the surface side (the side indicated by an arrow IV in FIG. 3, or the inner side) opposite to the surface opposing to the bottom side (left side in FIG. 3) of the case 2 of the holder 30, the above-mentioned four magnet positioning columns 39 are provided in a protruding condition as shown in FIG. 4. These magnet positioning columns 39 are inserted into spaces between the magnets 15 along the longitudinal direction of the four magnets 15 so that they are the references for positioning when the magnets 15 are fixed (adhered) to the inner surface of the case 2 with equal intervals, as well as the magnets 15 are adhered and fixed also to the magnet positioning columns 39. Each of the magnet positioning columns 39 has a shape of a plain plate in which, in order to fit with the magnets 15, the thickness of the one side (inner circumferential side), in the width direction, is made to be slightly thinner than that of the other side (outer circumferential side), and they are provided in protruding conditions in such a way that the four arranging directions are different by 90° to each other. Note that, in FIG. 4, for easy understanding, each portion of the inner side is denoted by the same symbol (name) as the symbol denoted to the corresponding portion of the outer side of the holder 30.

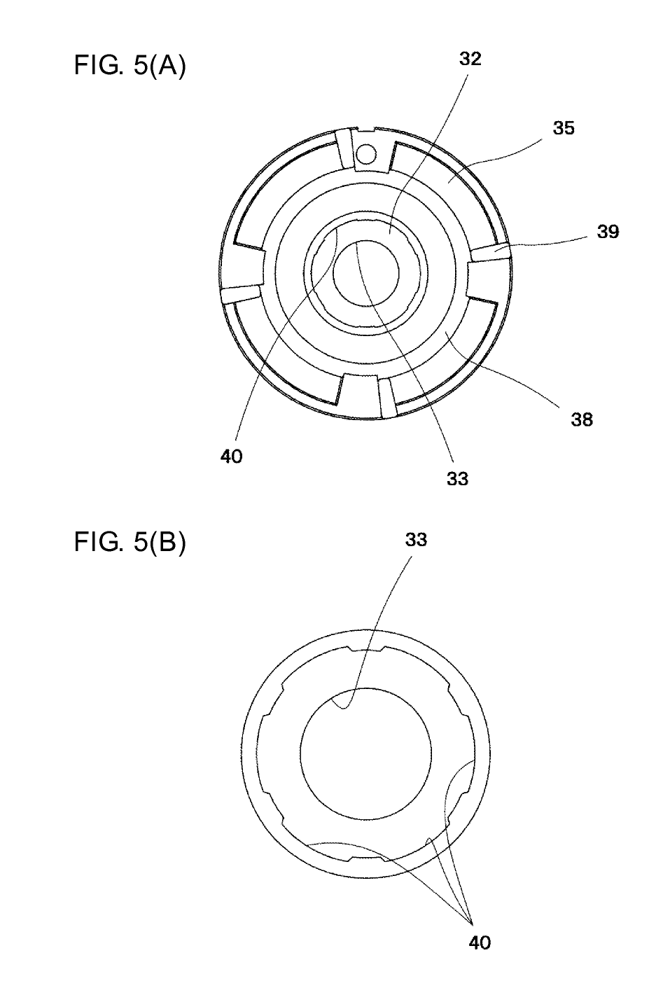

As shown in FIG. 4, six oil sump portions 40 having slot shapes are formed on an inner surface of the bearing holder portion 31. These oil sump portions 40 are formed at equal intervals. As shown in FIG. 1, the bearing 22 is pressed and fit (inserted) into the inner circumferential side of the bearing holder portion 31. In this example, as shown in FIG. 5(A) and FIG. 5(B), the sum of the areas of the oil sump portions 40 formed at equal intervals in the inner circumferential surface side of the bearing holder portion 31 is set to be larger than the sum of the other areas abutting the bearing 22.

As shown in FIG. 1 and FIG. 3, the position of the holder 30 is determined with respect to the case 2 by inserting and fitting the positioning projection 37 into the positioning hole 2b of the case 2 (see FIG. 3). At this time, the bearing holder portion 31 penetrates through the holder inserting hole 2a formed in the case 2 so as to be protruded to the outside of the case 2 (see FIG. 1), and the case abutting projections 36 of holder 30 are in a state to abut the case 2. Thus, the shaft 3 penetrates through the shaft inserting hole 33 to be protruded to the outside of the exterior case 2 and the holder 30.

FIG. 1 shows a state in which the brush motor 1 is attached to a motor attaching member 45 of the main body of the equipment. That is, a state is shown in which the bearing holder portion 31 of the holder 30 is inserted into a circular hole formed in the motor attaching member 45, and screws 46 are in threaded connection with the screw holes 2c formed in the case 2.

Next, operations of oil for the bearing (hereinafter referred to as oil) in the bearing 22 and the holder 30 will be explained separately when the motor is running and when the motor is resting.

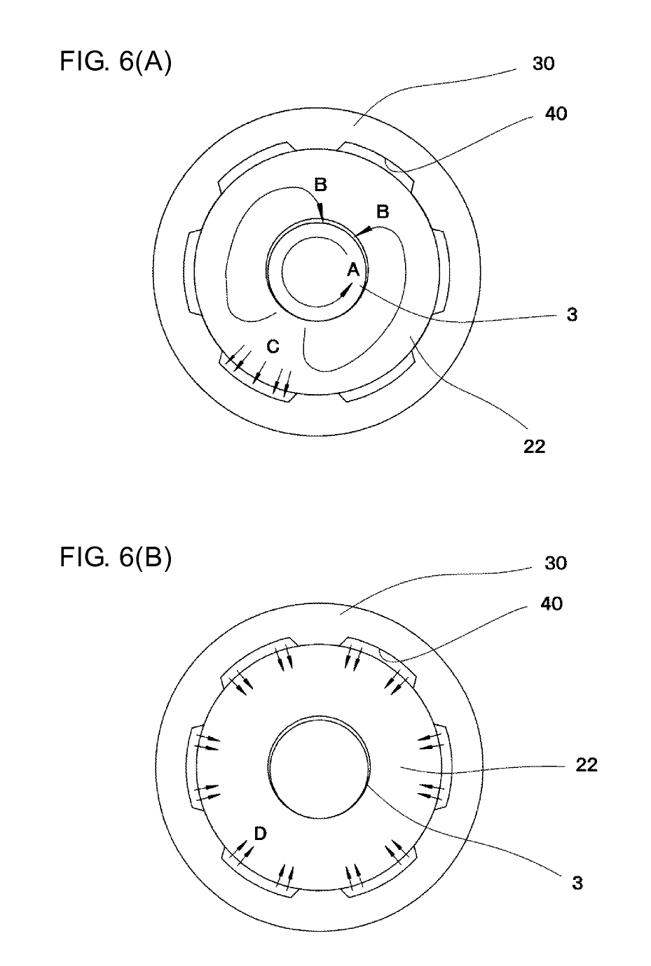

As shown in FIG. 6(A), when the motor is running (see an arrow A), the pressure at the portions where the bearing 22 makes a sliding contact with the shaft 3 becomes to be high so that the oil moves to the inner side (the side of the shaft 3) of the bearing 22. At portions of the bearing 22 where the bearing 22 does not make a sliding contact with the shaft 3, the pressure is low so that the oil moves in gaps between the bearing 22 and the shaft 3. Arrows B represent flows of the circulating oil. At the outer periphery of the bearing 22, the oil at portions where the pressure is increased moves to the outside direction. Further, when the temperature of the bearing 22 is increased due to the sliding contact with the shaft 3, the viscosity of the oil is lowered so that the oil further moves from the bearing 22 to the outside. Since the oil sump portions 40 are formed in the bearing holder portion 31, the oil which has moved from the bearing 22 to the outside does not flow out to the other portion but is pooled in the oil sump portions 40 (see an arrow C).

On the other hand, as shown in FIG. 6(B), when the motor is resting, the pressure difference between the portion at the oil sump portions 40 of the bearing holder portion 31 and at the portion of the bearing 22 making a sliding contact with the shaft 3 disappears, so that the oil tends to move to return to the side of the bearing 22 (see an arrow D). Thus, the amount of loss of the oil can be suppressed to be small.

Next, the function effects or the like of the brush motor 1 according to the present embodiment will be explained.

In the brush motor 1 according to the present embodiment, the screw holes 2c for attaching the motor to the bottom side of the case 2 are formed, however, no opening or hole is formed in the members (planar portion 34, taper portion 38, base portion 35, and the like) on the periphery of the bearing holder portion 31 of the holder 30. Therefore, even when dust or the like has invaded the motor through the screw holes 2c before attaching the motor, the member (outer periphery portion) around the bearing holder portion 31 of the holder 30 becomes a wall to have a structure to prevent foreign matter from invading into the side of the wiring portion, resulting in that it is possible to obviate a malfunction of operation due to invasion of foreign matter so as to improve the reliability. Further, since the top side of the bearing holder portion 31 is protruded from the holder inserting hole 2a formed in the case 2, the volume of the motor can be made small so as to realize downsizing.

Further, in the brush motor 1 according to the present embodiment, by the one member as the holder 30 which is constructed the cylindrical bearing holder portion 31, arranged at the central portion, and the holder 30 having the magnet positioning columns 39, arranged at the side of the magnets 15 on the outer periphery for positioning the magnets 15, a simultaneous positioning can be performed for the bearing 22 drawing the axis line of the rotor (shaft 3) and the magnets 15 fixed on the outside of the rotor and on the inner circumference of the case 2, so that the concentricity of them can be secured, and noise reduction can be attained.

That is, in comparison with the conventional technology in which the bearing and the magnets are respectively positioned separately with respect to the exterior case, the precisions of the positions can be improved so that the noise reduction can be attained. Further, since the bearing holder portion 31 and the magnet positioning columns 39 are constructed by one member as the holder 30, the number of parts can be reduced in comparison with the conventional technology in which the members for positioning the magnets are separately provided. Still further, since the holder 30 is constructed by a member made of resin, downsizing of the motor can be attained.

Still further, in the brush motor 1 according to the present embodiment, since the positioning projection 37 of the holder 30 is inserted into and fit with the positioning hole 2b so that the positioning of the holder 30 with respect to the case 2 is performed, and simultaneously, as mentioned above, the positioning of the bearing 22 and the magnets 15 is performed, the precisions of the positions of a plurality of parts can be secured, and the man-hours for assembling can be reduced. Still further, since the positioning projection 37 is formed on one of the blockish case abutting projections 36, the length of the pin-shaped positioning projection 37 can be made shortest, so that the positioning projection 37 can be made to be robust.

Still further, in the brush motor 1 according to the present embodiment, the holder 30 is a member made of resin and is provided with the oil sump portions 40, and the (oil retaining) bearing 22 is held in the bearing holder portion 31, thereby, as explained in the above-mentioned operation, the oil is prevented from flowing out to the outside so that the durability of the brush motor 1 can be improved. In addition, although there is a fear in that the oil may be flown to the outside because the holder 30 is a member made of resin so that its heat conductivity is low, and the temperature of the oil retaining bearing 22 will be increased, however, since the oil sump portions 40 are provided as a countermeasure, the oil can be prevented from flowing out.

Note that, in the present embodiment, the present invention is applied to a brush motor as an example. However, as a matter of course, the present invention can be applied to various motors other than the brush motor.

Further, in the present embodiment, as the oil sump portions 40 in the holder 30, the slots with substantially the same depth (having rectangular shapes) have been shown as an example, however, the present invention is not limited to this but they may be, for example, slots having cross sections of inverted triangles or arcs.

Still further, in the present embodiment, an example has been shown in which the positioning projection 37 in the holder 30 is inserted into and fit with the positioning hole 2b so that the positioning of the holder 30 with respect to the case 2 is performed, however, in contrast to this, it may also be possible that a positioning projection provided on the side of the case 2 in a protruding condition may be inserted into and fit with a positioning hole formed in one of the case abutting projections 36 so that the positioning of the holder 30 with respect to the case 2 is performed. Still further, in the present embodiment, an example has been shown in which the positioning projection 37 is provided to protrude from one of the case abutting projections 36, however, the present invention is not limited to this, but it may also be possible to construct a protrusion, for example, from the circumference (for example, the planar portion 34 or the base portion 35) of the bearing holder portion 31 toward the side of the case 2. Still further, there may be a plurality of positioning projections 37 or positioning holes 2b.

Further, in the present embodiment, the mode of each construction, the material in use, or the number of the members are not limited to the present embodiment but should be changed in view of cost, mutual relationship, or the like, and can be changed by combining with publicly known technologies without departing from the scope of claims.

This application claims priority from Japanese Patent Application No. 2011-287703 filed on Dec. 28, 2011.

1. A motor comprising an exterior case, a rotor including a wiring portion wound around an iron core fixed to a rotating shaft, a bearing in a sliding contact with the rotating shaft to support the rotating shaft, and a bearing holder made of resin and arranged at one side of the rotating shaft and holding the bearing, wherein
the bearing holder comprises a central portion with a cylindrical shape, including a top portion protruding from an opening formed in the exterior case, and an inner circumferential side into which the bearing is inserted; and an outer circumferential portion shielding an inner surface side of the exterior case and the winding portion.

2. The motor as claimed in claim 1, wherein a plurality of oil sump portions are provided on the inner circumferential side of the central portion of the bearing holder.

3. The motor as claimed in claim 1, wherein a positioning projection is provided on either one of the outer circumferential portion of the bearing holder and the exterior case, the positioning projection being fit with a hole formed on another one of the outer circumferential portion of the bearing holder and the exterior case so as to perform a positioning of the bearing holder with respect to the exterior case.

4. The motor as claimed in claim 1, wherein a plurality of projecting abutting portions abutting against the inner surface side of the exterior case are provided on the outer circumferential portion of the bearing holder, the positioning projection being provided on the projecting abutting portions.

5. The motor as claimed in claim 1, wherein a plurality of magnets are provided to be arranged at an outer side of the winding portion and to be separately fixed at an inner circumferential side of the exterior case, and a plurality of projections positioning the magnets are provided on an outer circumferential portion of the bearing holder to be projected toward sides of the magnets.

6. The motor as claimed in claim 1, wherein a screw hole fixing the motor is formed in the exterior case and at a side of the bearing holder.

7. The motor as claimed in claim 2, wherein the oil sump portions are formed to have shapes of slots placed at predetermined intervals on the inner circumferential side of the central portion of the bearing holder.

8. The motor as claimed in claim 7, wherein the sum of the areas of the oil sump portions formed on the inner circumferential side of the bearing holder placed at the predetermined intervals is larger than the sum of areas where the inner circumferential side of the central portion abut against the bearing.

9. The motor as claimed in claim 4, wherein the positioning projection is provided on either one of at least one projecting abutting portion of the plurality of projecting abutting portions and the exterior case, the positioning projection being fit into a hole formed in another one of at least one projecting abutting portion of the plurality of the projecting abutting portions and the exterior case so as to perform the positioning of the bearing holder with respect to the exterior case.

10. The motor as claimed in claim 5, wherein the magnets are adhered and fixed to the projections.
